(19) United States
(12) Patent Application Publication
(10) Pub. No.: US 2012/0035331 A1
(43) Pub. Date: Feb. 9, 2012

(54) POLYALKYLTHIOPHENE BLOCK COPOLYMER AND A METHOD OF PREPARING THE SAME THROUGH A RING-OPENING METATHESIS POLYMERIZATION REACTION

(75) Inventors: Hyun-ji Kim, Seoul (KR); Yun-Jae Lee, Gyeonggi-do (KR); Kie-Yong Cho, Gyeonggi-do (KR); Soon-Man Hong, Seoul (KR); Seung-Sang Hwang, Seoul (KR); Jyung-Youl Baek, Seoul (KR)

(73) Assignee: KOREA INSTITUTE OF SCIENCE AND TECHNOLOGY, Seoul (KR)

(21) Appl. No.: 13/265,258

(22) PCT Filed: Apr. 28, 2010
(86) PCT No.: PCT/KR10/02688

§ 371 Date: Oct. 19, 2011

(30) Foreign Application Priority Data
Apr. 28, 2009 (KR) 10-2009-0037319

(51) Int. Cl. C08G 75/06

(52) U.S. Cl. 525/417

(57) ABSTRACT

A polyalkylthiophene block copolymer, a conductive composition including the same, a polymer-catalyst complex in which a polyalkylthiophene and a transition metal catalyst are connected, and a method of preparing a conductive block copolymer from the polymer-catalyst complex through a ring-opening metathesis reaction are provided.

### FIELD OF THE INVENTION

A polyalkylthiophene block copolymer, a conductive composition including the same, a polymer-catalyst complex in which a polyalkylthiophene and a transition metal catalyst are combined, and a method of preparing a conductive block copolymer from the polymer-catalyst complex through a ring-opening metathesis reaction are provided.

### BACKGROUND OF THE INVENTION

Polyalkylthiophene is a chemically and thermally stable compound and a material having a large potential to be used to an organic solar cell, a smart window system, a photoelectronic field, an organic light emitting diode (OLED), and the like. Here, McCullough of U.S. (Richard D. McCullough, Facile-synthesis of terminal-functionalized regio-regular poly(3-alkylthiophene)s via modified grignard metathesis reaction, macromolecules 2005, 38, 10346-10352) and Yokozawa of Japan (Tsutomu Yokozawa, Catalyst-Transfer polycondensation. Mechanism of Ni-catalyzed chain-growth polymerization leading to well-defined poly(3-hexylthiophene), J. AM. CHEM. SOC. 2005, 127, 17542-17547) have carried out many studies about a synthesis of regio-regular polyalkylthiophene in which alkyl thiophene is connected in head to tail tacticity and a polyalkylthiophene of which terminal group is functionalized by an in-situ reaction.

Cyclic olefin polymers can be easily synthesized through a ring-opening metathesis polymerization (ROMP), the rate of polymerization is rapid and it is easy to polymerize various types of norbornene derivative monomers. Various studies about catalysts for ROMP reaction have been globally carried out, and Grubbs catalyst (Robert H. Grubbs, Living ring-opening metathesis polymerization, prog. polym. sci, 32, 2007, 1-29) and Schrock catalyst are representative. Here, a norbornene-based cyclic olefin block copolymer which has various chemical components and structures based on a polyalkylthiophene and has controlled molecular weight and molecular weight distribution can be easily prepared by designing the terminal group of the polyalkylthiophene, a conductive polymer, for introducing the Grubbs catalysts of the first generation, the second generation, and the third generation to the terminal group, and using the same as a macro-initiator.

Recently, studies for block copolymers based on polyalkylthiophene and having controlled molecular weight and molecular weight distribution are being carried out actively by using an atom transfer radical polymerization (ATRP), a reversible addition fragmentation chain transfer (RAFT), and a nitroxide mediated polymerization (NMP), however, studies of using a ring-opening metathesis polymerization to the polyalkylthiophene have been insufficient.

### SUMMARY OF THE INVENTION

It is an aspect of the present invention to provide a block copolymer including polyalkylthiophene and polynorbornene-based compound.

It is another aspect of the present invention to provide a polymer-catalyst complex in which polyalkylthiophene and transition metal catalyst are combined.

It is still another aspect of the present invention to provide a method of preparing the block copolymer from the polymer-catalyst complex through a ring-opening metathesis polymerization reaction.

### BRIEF DESCRIPTION OF THE DRAWINGS

FIG. 1 shows the synthesis reaction formula of Example 1(1) and ¹H NMR spectra of synthesized 3-hexylthiophene and 2,5-dibromo-3-hexylthiophene.

FIG. 2 shows ¹H NMR result of P3HT(2) having vinyl terminal group of Example 2.

FIG. 3 shows the results of GPC and MALDI-TOF analysis of P3HT(2) having vinyl group at the terminal group of Example 1.

FIG. 4 shows ¹H NMR result of P3HT having Ru catalyst at the terminal group of Example 1.

FIG. 5 shows ¹H NMR result of P3HT-b-PNBE of Example 1.

FIG. 6 shows a comparison between P3HT precursor and P3HT-b-PNBE of Example 1.

FIG. 7 shows ¹H NMR result of P3HT(2) having vinyl terminal group of Example 4.

FIG. 8 shows the results of GPC and MALDI-TOF analysis of P3HT(2) having vinyl group at the terminal group of Example 4.

FIG. 9 shows GPC result of P3HT having Ru catalyst at the terminal group of Example 4.

FIG. 10 shows ¹H NMR result of P3HT having Ru catalyst at the terminal group of Example 4.

FIG. 11 shows a comparison between P3HT precursor and P3HT-b-PNBE of Example 4.

### DETAILED DESCRIPTION

The present invention provides a block copolymer of polyalkylthiophene and norbornene-based compound prepared by a ring-opening metathesis polymerization based on polyalkylthiophene, and a preparation method thereof.

One embodiment of the present invention provides a polyalkylthiophene block copolymer in which a norbornene-based compound is connected to and polymerized with the polyalkylthiophene through a ring-opening metathesis reaction, and a conductive composition including the block copolymer. More specifically, the polyalkylthiophene block copolymer according to the present invention may have the structure of following Chemical Formula 1:

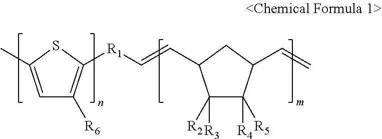

In the Chemical Formula, R₁ may be selected from any compounds having a structure capable of resonance to vinyl groups, for example, it may be a substituted or unsubstituted phenyl, a substituted or unsubstituted thiophene, a substituted or unsubstituted pyrrole, a substituted or unsubstituted pyridine, a substituted or unsubstituted ring compound such as triazole ring, a carbonyl compound such as ketone and ester, or an aliphatic compound of conjugation structure.

The substituent included in said substituted phenyl, thiophene, pyrrole, pyridine, or triazole ring may be selected from the group consisting of a C1-C20 alkyl, a C2-C20 alkenyl, a C2-C20 alkynyl, a C5-C20 aryl, a C6-C24 alkaryl, and a C6-C24 aralkyl. The ketone is a C1-C12 ketone, and it may be selected from the group consisting of acetone, methyl ethyl ketone, methyl propyl ketone, diethyl ketone, methyl butyl ketone, methyl isobutyl ketone, methyl amyl ketone, methyl hexyl ketone, cyclohexanone, methyl cyclohexanone, isophorone, acetyl acetone, methyl phenyl ketone, and the like. The ester may be a C1-C20 ester compound. The aliphatic compound of conjugation structure is an aliphatic compound having a conjugation structure, and it may be selected from the group consisting of a C1-C20 alkyl, a C6-C20 aryl, a C3-C20 cycloalkyl, a heteroatom-containing C1-C20 alkyl, a C6-C20 aryl, a C1-C20 arylalkyl, a C1-C20 alkylaryl, a C1-C20 alkoxy, and a C1-C20 alkyloxy, and the heteroatom means what is commonly used in the related art, and for example, it may be selected from the group consisting of S, O, N, and a halogen atom.

R₂-R₅ are substituents included in the norbornene-based monomer, and they may be identical or different each other and independently selected from the group consisting of hydrogen, a hydrocarbyl, a substituted hydrocarbyl, a heteroatom-containing hydrocarbyl, a substituted heteroatom-containing hydrocarbyl, and amino group, or a ring structure formed by R₃ and R₄, or a ring structure formed by heteroatom-containing R₃ and R₄.

The hydrocarbyl may be selected from the group consisting of a substituted or unsubstituted C1-C20 alkyl, a substituted or unsubstituted C2-C20 alkenyl, a substituted or unsubstituted C2-C20 alkynyl, a substituted or unsubstituted C5-C20 aryl, a substituted or unsubstituted C6-C24 alkaryl, and a substituted or unsubstituted C6-C24 aralkyl. The heteroatom means what is commonly used in the related art, and for example, it may be selected from the group consisting of S, O, N, and a halogen atom.

The substituent included in the substituted alkyl, alkenyl, alkynyl, aryl, alkaryl, or aralkyl may be selected from the group consisting of a C1-C20 alkyl, a C2-C20 alkenyl, a C2-C20 alkynyl, a C5-C20 aryl, a C6-C24 alkaryl, and a C6-C24 aralkyl.

R₆ is a substituent of the thiophene monomer, and it may be a C1-C12 alkyl group. Said n and m represent the number of monomers of the polyalkylthiophene and the ring-opened norbornene-based polymer respectively, and n may be an integer of 5 to 400 and m may an integer of 5 to 20,000.

In the conductive composition including the polyalkylthiophene block copolymer according to the present invention, ‘conductive’ means not only that all monomers of the block copolymer show conductivity but also that at least some monomers show conductivity.

The polyalkylthiophene included in the block copolymer according to the present invention may have a head to tail tacticity, and the degree of head to tail tacticity may be 90% or more.

The conductive composition according to the present invention can be widely applied to the fields of solar cell, photoelectronic, light emitting diode, and the like, and for example, it can be applied to a sensor, a display, a transistor, a diode (i.e. organic light emitting diode), and the like, however, it is not limited to these.

Another embodiment of the present invention provides a polymer-catalyst complex including a polymer having a structure of following Chemical Formula 2 and a transition metal catalyst connected to R₁ of terminal group of the polymer, as a material capable of initiating the ring-opening metathesis reaction of the polyalkylthiophene and the norbornene-based compound:

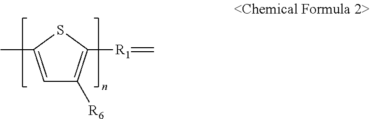

Wherein, R₁, R₆, and n are same as defined in Chemical Formula 1.

The transition metal catalyst connected to R₁ of terminal group of the polymer having the structure of Chemical Formula 2 is a transition metal catalyst including a transition element of groups 5 to 9, for example, it may be at least one selected from the group consisting of the transition metal catalysts including at least one selected from the group consisting of ruthenium (Ru), molybdenum (Mo), rhodium (Rh), tantalum (Ta), osmium (Os), and the like.

For example, the transition metal catalyst including ruthenium may be a Grubbs catalyst, the first generation Grubbs catalyst may have the structure of following Chemical Formula a, the second generation Grubbs catalyst may have the structure of following Chemical Formula b, the third generation Grubbs catalyst may have the structure of following Chemical Formula c, and it may have the structure of Chemical Formulae d-f, except for that, however, it is not limited to these.

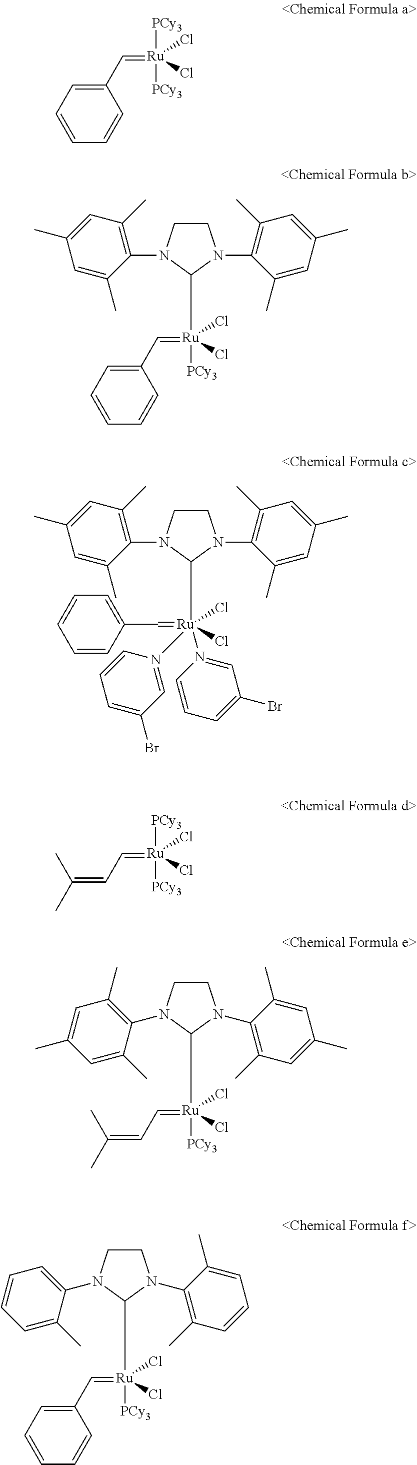

For example, the transition metal catalyst including molybdenum may be a Schrock catalyst, however, it is not limited to this. The transition metal catalyst including molybdenum may have the structure of following Chemical Formulae g, h, i, j, k, l, m, and n, however, it is not limited to these.

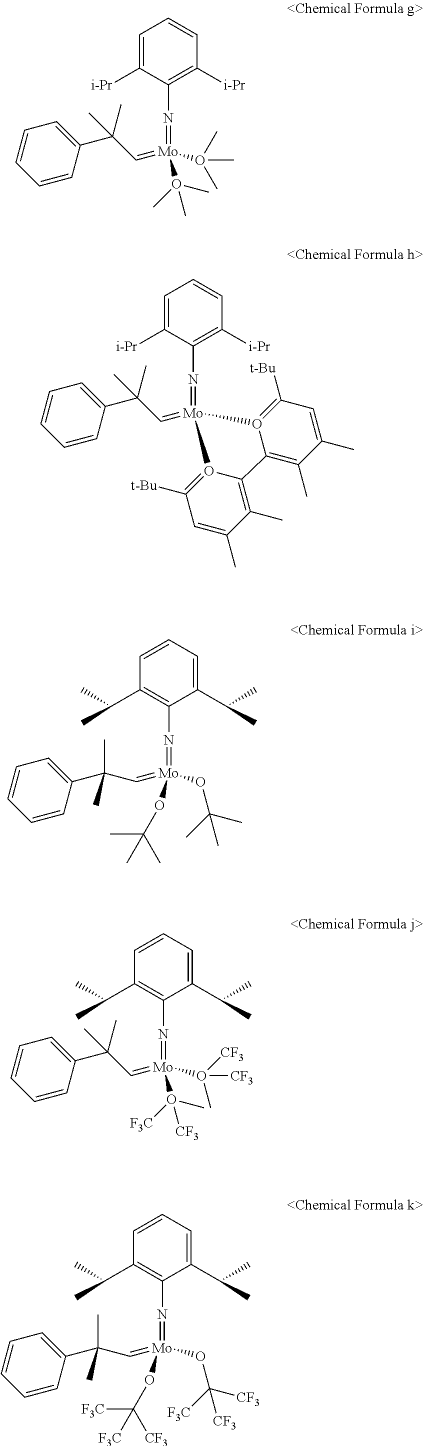

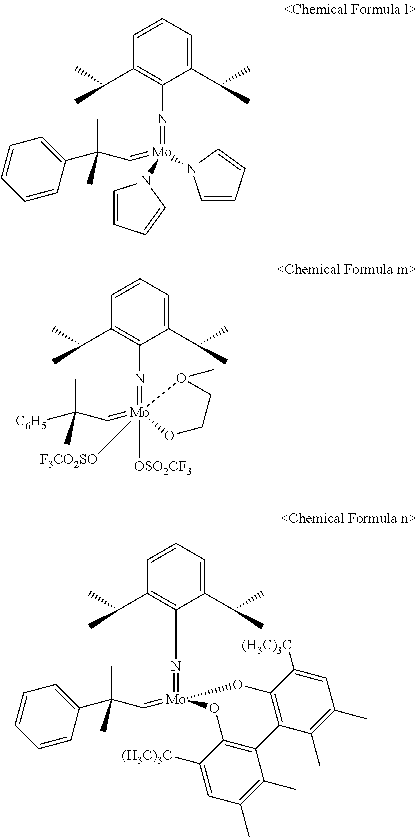

In one embodiment of the present invention, the polymer-catalyst complex may include the first generation Grubbs catalyst of Chemical Formula a or the ruthenium catalyst of Chemical Formula d, and it may have the structure of following Chemical Formula 3:

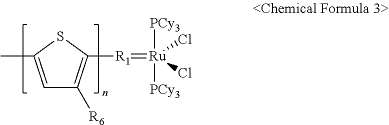

In another embodiment, the polymer-catalyst complex may include the second generation Grubbs catalyst of Chemical Formula b or the ruthenium catalyst of Chemical Formula e, and it may have the structure of following Chemical Formula 4:

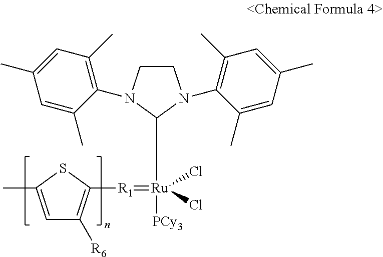

In another embodiment, the polymer-catalyst complex may include the third generation Grubbs catalyst of Chemical Formula c, and it may have the structure of following Chemical Formula 5:

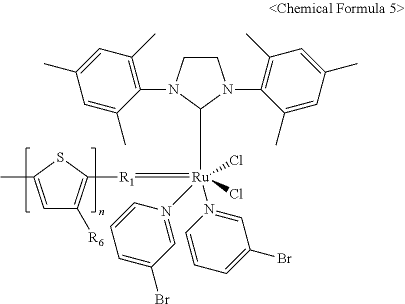

In another embodiment, the polymer-catalyst complex may include the ruthenium catalyst of Chemical Formula f, and it may have the structure of following Chemical Formula 6:

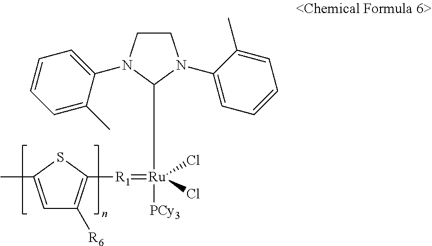

In addition to, when the transition metal catalyst includes molybdenum, the polymer-catalyst complex may have a structure of following Chemical Formulae 7 to 14. The structure of following Chemical Formula 7 may include the molybdenum catalyst of Chemical Formula g:

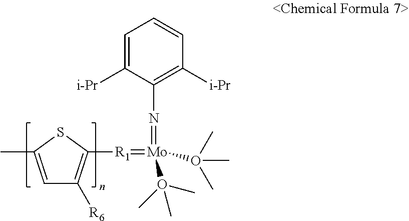

In another embodiment, the polymer-catalyst complex may include the molybdenum catalyst of Chemical Formula h, and it may have the structure of following Chemical Formula 8:

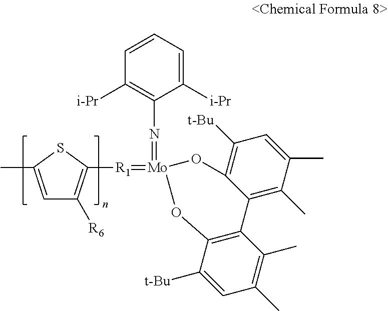

In another embodiment, the polymer-catalyst complex may include the molybdenum catalyst of Chemical Formula i, and it may have the structure of following Chemical Formula 9:

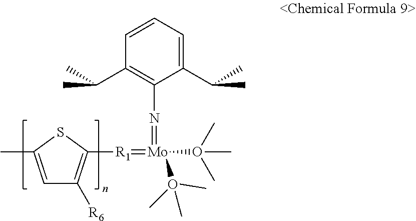

In another embodiment, the polymer-catalyst complex may include the molybdenum catalyst of Chemical Formula j, and it may have the structure of following Chemical Formula 10:

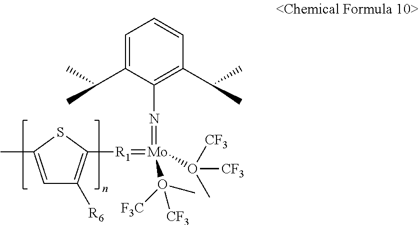

In another embodiment, the polymer-catalyst complex may include the molybdenum catalyst of Chemical Formula k, and it may have the structure of following Chemical Formula 11:

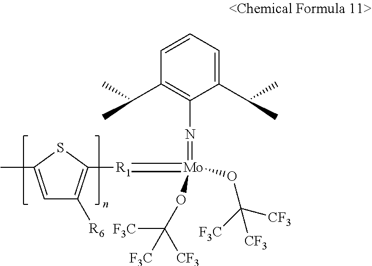

In another embodiment, the polymer-catalyst complex may include the molybdenum catalyst of Chemical Formula 1, and it may have the structure of following Chemical Formula 12:

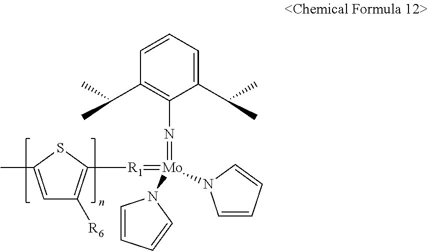

In another embodiment, the polymer-catalyst complex may include the molybdenum catalyst of Chemical Formula m, and it may have the structure of following Chemical Formula 13:

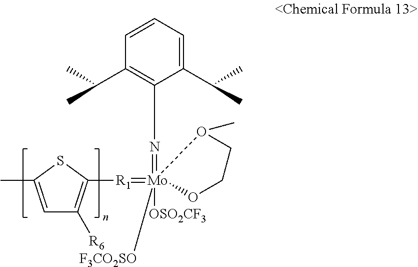

In another embodiment, the polymer-catalyst complex may include the molybdenum catalyst of Chemical Formula n, and it may have the structure of following Chemical Formula 14:

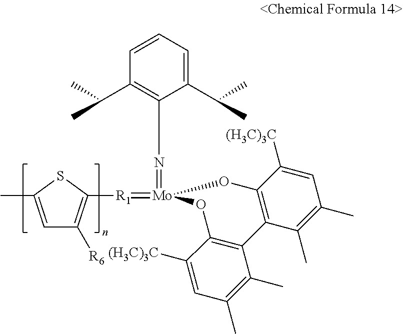

In Chemical Formulae 3 to 14, R₁, R₆, and n are same as defined in Chemical Formula 1.

The polymer-catalyst complex may be prepared by the step of reacting the compound of Chemical Formula 2 and the transition metal catalyst in an adequate solvent. At this time, it is preferable for increasing the reactivity (particularly the reactivity of forward reaction) to use an excess of the transition metal catalyst, and the amount may be preferably 1 to 5 based on the number of moles of the terminal vinyl groups of the compound of Chemical Formula 2. Furthermore, the solvent is not limited particularly, however, it may be at least one selected from the group consisting of chlorine-based solvents which are good solvent for poly3-hexylthiophene (P3HT) such as methylene chloride, chloroform, toluene, chlorobenzene, and the like,

Still another embodiment of the present invention provides a method of preparing the polyalkylthiophene block copolymer of Chemical Formula 1, by adding the norbornene-based compound to the polymer-catalyst complex and carrying out the ring-opening metathesis reaction.

More specifically, the method may include the steps of:

1) adding a norbornene-based compound of following Chemical Formula 15 to the polymer-catalyst complex and carrying out a ring-opening metathesis reaction; and

2) terminating the reaction by eliminating the catalyst:

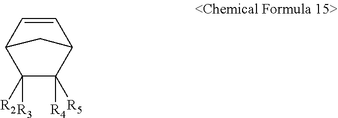

wherein, R₂-R₅ are same as defined in Chemical Formula 1.

The metathesis reaction of step 1) may be carried out in an adequate solvent, and the solvent is not limited particularly, however, it may be at least one selected from the group consisting of chlorine-based solvents which are good solvent for poly3-hexylthiophene (P3HT) such as methylene chloride, chloroform, toluene, chlorobenzene, and the like,

The preparation method of the present invention is instantiated in more detail as follows.

In one embodiment of the present invention, the compound having the structure of following Chemical Formula 1-1 which is a monomer of polyalkylthiophene of Chemical Formula 1 and is characterized in that R₆ is hexyl group, and positions 2 and 5 are occupied by halogen atom, for example, bromine may be used.

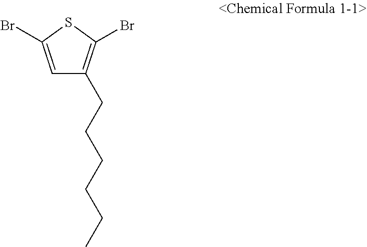

Following Reaction Formula 1 represents the processes of polymerizing the polyalkylthiophene by using the monomer of Chemical Formula 1-1 and carrying out the terminal functionalization through an in-situ reaction, and the polymer prepared in this way is characterized in that an alkene group is included at the terminal group.

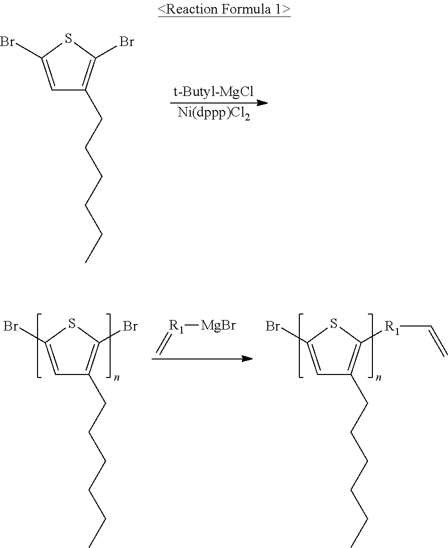

The compound of following Chemical Formula 3-1 represents an example of the polyalkylthiophene-catalyst complex (the compound of Chemical Formula 3) as a macro-initiator which is synthesized by attaching the first generation Grubbs catalyst used in above embodiment of the present invention to the terminal group of the polyalkylthiophene which is the final product compound of said Reaction Formula 1 through an alkene-transfer reaction, and it is characterized in that the terminal group of the polyalkylthiophene is combined to the benzylidene part of the first generation Grubbs catalyst.

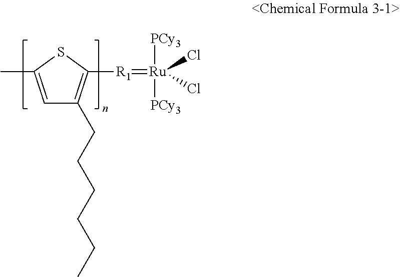

The preparation method according to one embodiment of the present invention may employ the method of Reaction Formula 1 and the compound of Chemical Formula 3-1, and it may be represented by following Reaction Formula 2:

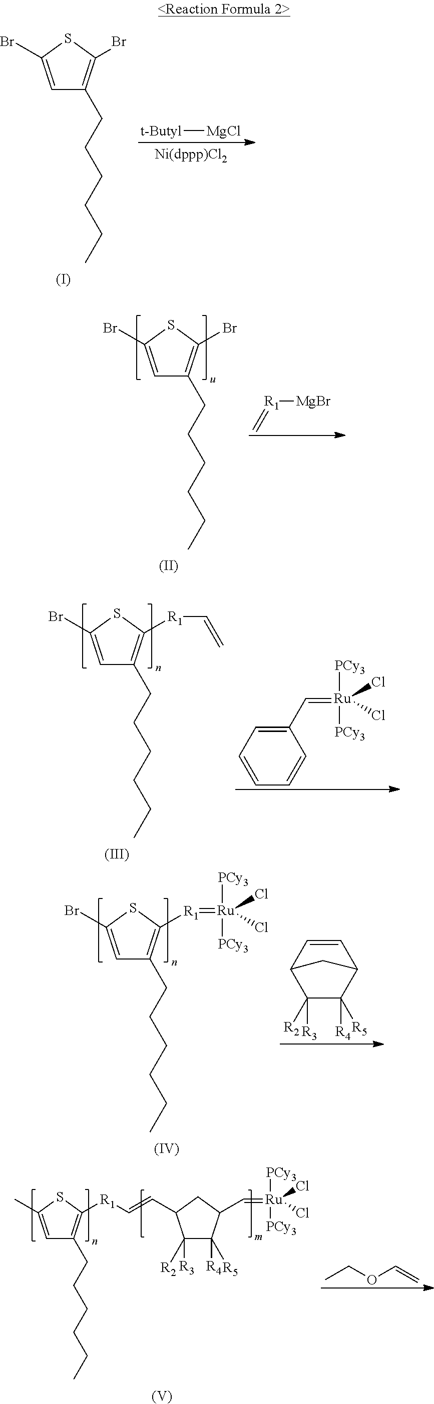

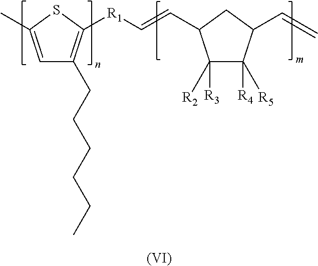

The compound of Chemical Formula V in above Reaction Formula 2 represents the polyalkylthiophene block copolymer-catalyst complex which is synthesized through the ring-opening metathesis reaction by using the polyalkylthiophene-catalyst complex as an initiator.

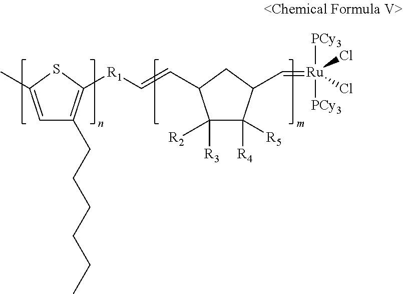

The compound of Chemical Formula VI in above Reaction Formula 2 represents the final polyalkylthiophene block copolymer after the catalyst is eliminated from the compound of Chemical Formula V by using ethyl vinyl ether.

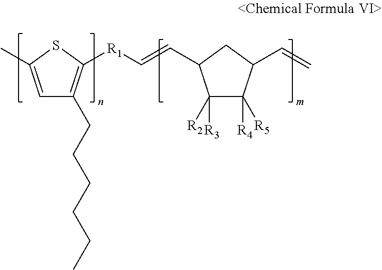

The preparation method of the polyalkylthiophene block copolymer according to above Reaction Formula 2 may carry out:

the first reaction step of using t-butyl magnesium chloride and [1,3-bis(diphenylphosphino)propane]dichloronickel (II) for synthesizing regio-regular polyalkylthiophene from 2,5-dibromo-3-hexylthiophene which is a monomer;

the second reaction step of in-situ synthesizing the polyalkylthiophene having alkyne terminal group by carrying out a Grignard coupling reaction of the polyalkylthiophene polymerized by using vinyl magnesium bromide as a Grignard reagent;

the third reaction step of preparing the polyalkylthiophene-catalyst complex like Chemical Formula IV (or Chemical Formula 3-1) in which the polyalkylthiophene having vinyl terminal group synthesized in the second reaction step is connected to the benzylidene ligand position of the Grubbs catalyst;

the fourth reaction step of reacting the compound of Chemical Formula IV (or Chemical Formula 3-1) synthesized in the third reaction step and a norbornene-based monomer; and

the fifth reaction step of eliminating the catalyst for preparing the block copolymer in which the polyalkylthiophene and the polynorbornene are combined.

The regio-regular polyalkylthiophene polymer (Chemical Formula 2) according to one embodiment of the present invention is polymerized from the monomer of Chemical Formula 15 and synthesized through the Grignard metathesis reaction; R₁ included in the compound may be derived from R₁ having vinyl group included in the Grignard reagent represented in Reaction Formula 2, and R₁ included in the Grignard reagent may be same as defined in Chemical Formula 1, however, it is not limited to this. Through the in-situ reaction with the Grignard reagent, the vinyl group can be introduced to the terminal group of the polyalkylthiophene polymer and it is possible to obtain the stereo-regular polyalkylthiophene with vinyl terminal group.

The macro-initiator material of Chemical Formula 3 causes a ring-opening metathesis polymerization with the norbornene-based monomer of Chemical Formula 15, and there is an advantage of that the reaction is favorable because the Grubbs catalyst is located at terminal group of the polymer due to the nature of the ring-opening metathesis polymerization when the reaction progresses and the monomer can easily access to the catalyst. Namely, above macro-initiator material has a structure of that the vinyl terminal group of the polyalkylthiophene is combined to the benzylidene ligand of the Grubbs catalyst.

As the macro-initiator material, for example, the polymer-catalyst complex may be the complex compound of Chemical Formula 4 in which the benzylidene ligand of the second generation Grubbs catalyst and the vinyl terminal group of the polyalkylthiophene are combined, and the complex compound of Chemical Formula 5 in which the benzylidene ligand of the third generation Grubbs catalyst and the vinyl terminal group of the polyalkylthiophene are combined, in addition to the complex of Chemical Formula 3 in which stereo-regular polyalkylthiophene with vinyl terminal group is connected to the benzylidene ligand of the first generation Grubbs catalyst.

In one embodiment, the block copolymer of the present invention may be prepared by using the complex compound of Chemical Formula 4 according to following Reaction Formula 3.

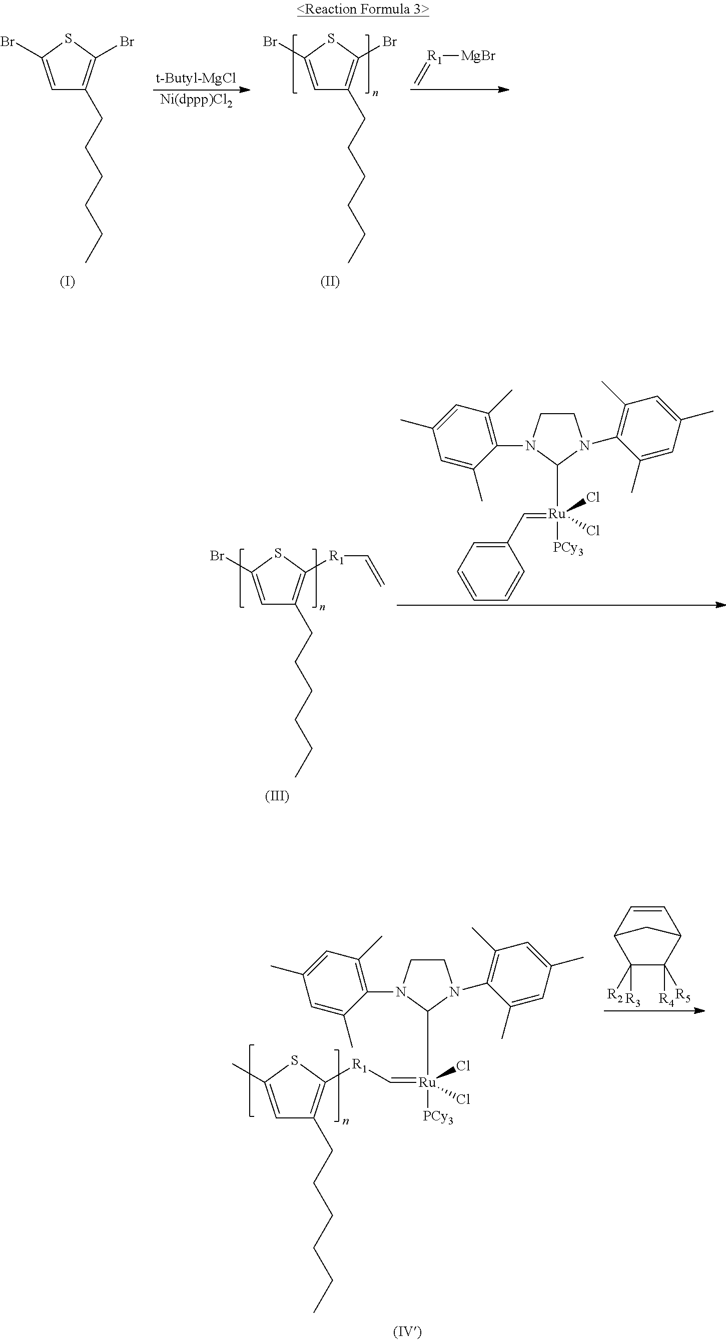

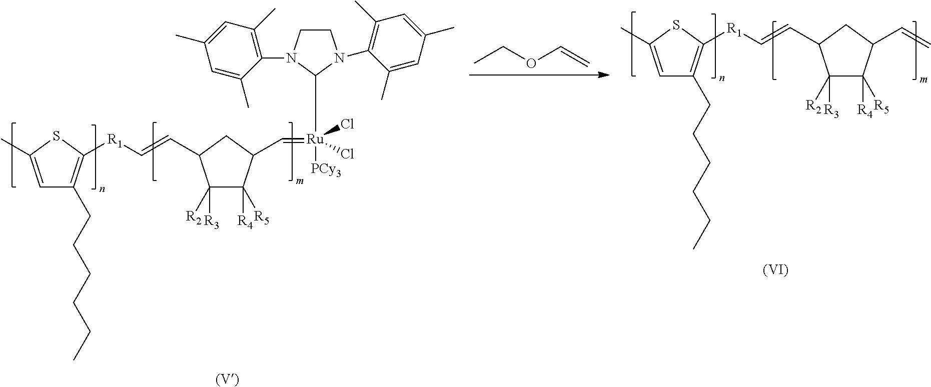

In another embodiment, the block copolymer of the present invention may be prepared by using the complex compound of Chemical Formula 5 according to following Reaction Formula 4.

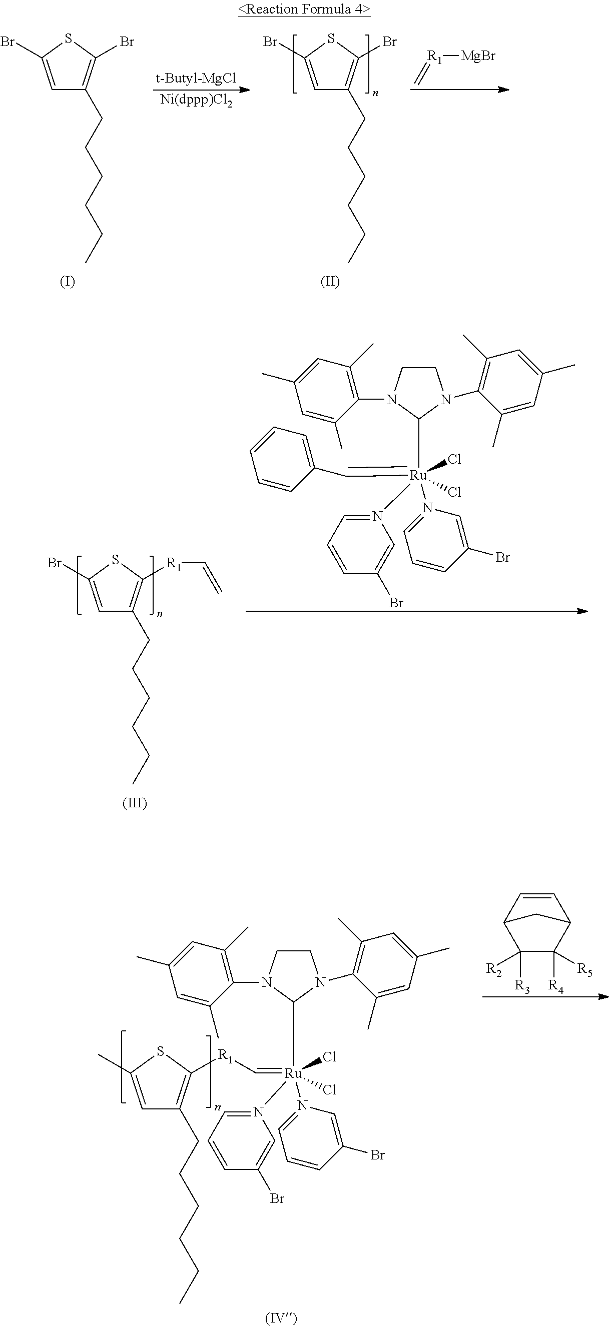

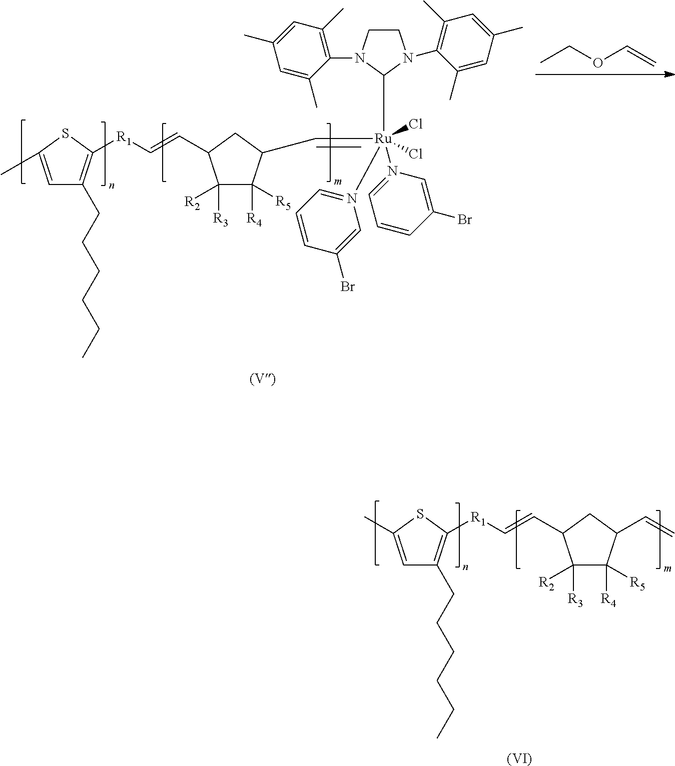

Hereinafter, the present invention is explained in more detail by following Examples. However, following examples are only for illustrating the present invention and the range of the present invention is not limited to or by them.

### Example 1

### Preparation of Polyalkylthiophene Block Copolymer by Using the First Generation Grubbs Catalyst

(1) Synthesis of 2,5-dibromo-3-hexylthiophene monomer

It was synthesized according to following Reaction Formula 5.

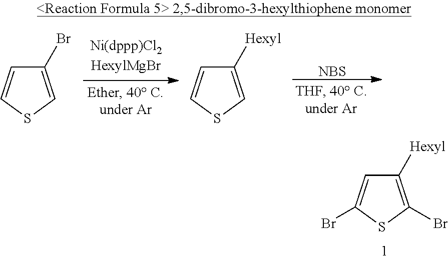

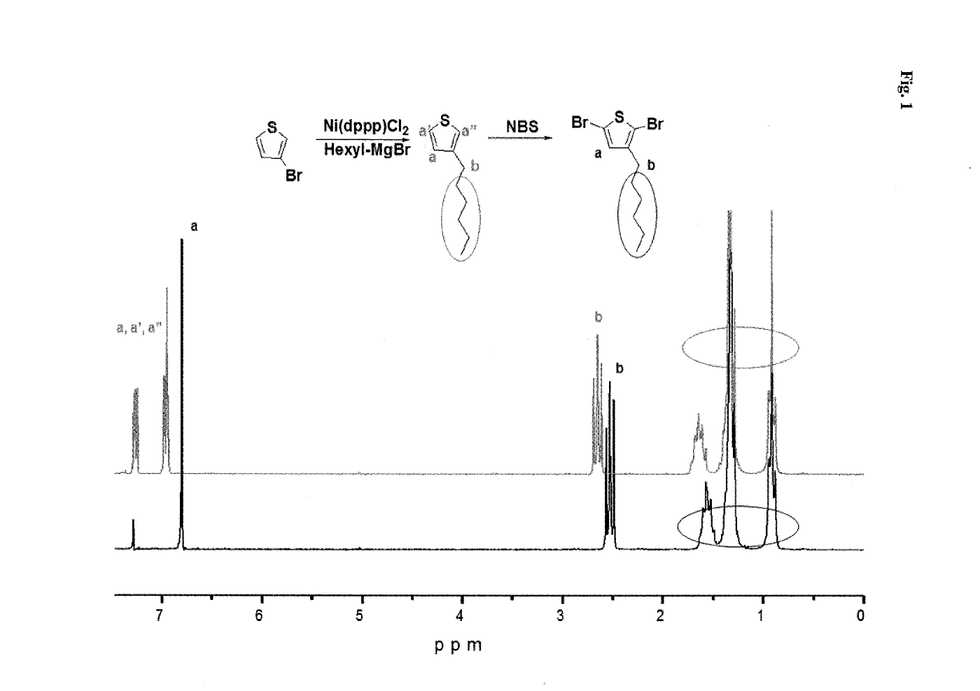

After synthesizing 3-hexylthiophene from 3-bromothiophene monomer (50 g, 0.3067 mol) and hexyl-MgBr (2.0M 199.36 ml) in the presence of [1,3-bis(diphenylphospliino)propane]dichloronickel (II) (Ni(dppp)Cl₂) catalyst (0.2 g, 0.36804 mmol), 2,5-dibromo-3-hexylthiophene monomer (monomer 1) was synthesized by substituting hydrogen at positions 2 and 5 with bromine by using 2 equivalents of n-bromosuccimide (NBS) (52.47 g 0.2948 mol). The synthesized monomer was analyzed by 1H NMR and the result is illustrated in FIG. 1.

(2) Synthesis of P3HT Having Vinyl Terminal Group

It was synthesized according to following Reaction Formula 6.

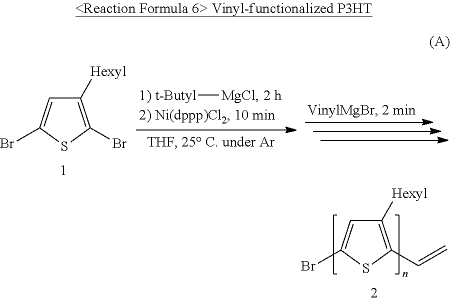

The synthesized monomer 1 (5 g, 0.01395 mol, 3.2873 ml) was dehydrated and dissolved in deaerated tetrahydrofuran (THF, 30 ml), and t-butyl-MgCl (2.0M 6.975 ml) which was prepared beforehand was injected into the solution under argon atmosphere and the solution was reacted for 2 hours at room temperature so as to change the compound into the Grignard reagent by substituting bromine at position 2 of 2,5-dibromo-3-hexylthiophene with MgBr. And then, after introducing 70 ml of THF additionally, Ni(dppp)Cl₂ (0.23 g) was added thereto as a catalyst and initiator and the solution was reacted for about 10 minutes at room temperature so as to prepare poly3-hexylthiophene (P3HT) by the coupling reaction of the nickel catalyst and 2,5-dibromo-3-hexylthiophene which was changed into the Grignard reagent.

In this state, vinyl-MgBr reagent (1.0M, 2.79 ml), a Grignard reagent, was added thereto and the solution was reacted for about 2 minutes in order to substitute the terminal group with vinyl group, and the polymerization was quenched by adding methanol (1 L) (compound A in Reaction Formula 6). The synthesized poly3-hexylthiophene (P3HT) was precipitated in methanol, and extracted by using a glass filter. The extracted P3HT of which vinyl group was introduced to the terminal group (hereinafter ‘P3HT(2)’) was purified through soxhelet with pentane.

Hereinafter, P3HT of which vinyl group is introduced to the terminal group is denoted by ‘P3HT(2)’ in order to distinguish it from P3HT to which vinyl group is not introduced.

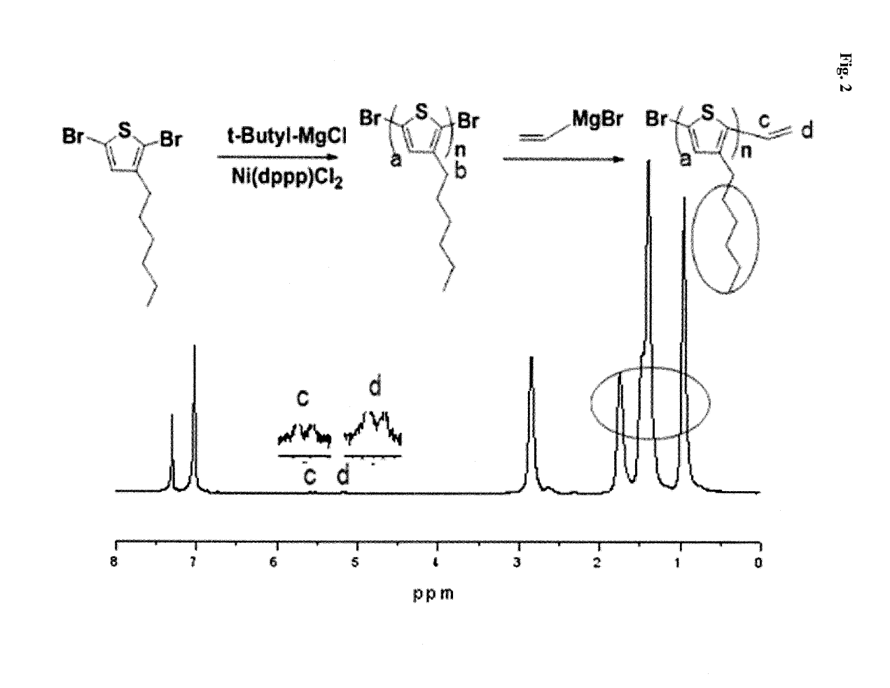

The ¹H NMR result of the synthesized P3HT(2) having vinyl terminal group is illustrated in FIG. 2. As shown in FIG. 2, the peaks caused by the vinyl terminal group is represented, as a result of integral calculation of the peaks, it can be known that the vinyl group is almost quantitatively introduced to the terminal of P3HT.

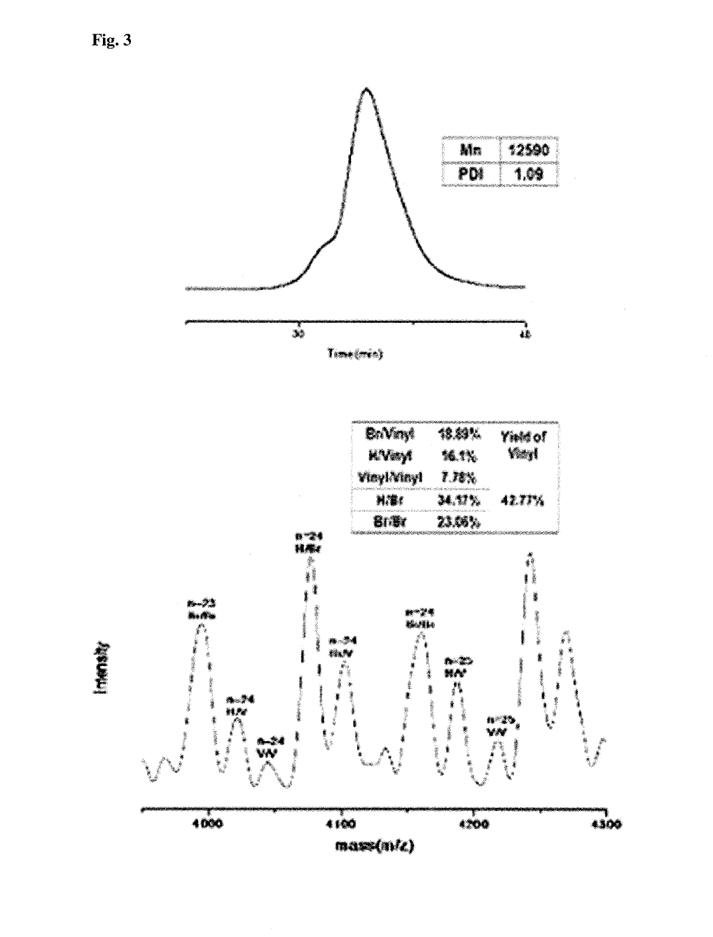

The GPC (gel permeation chromatography, LC-NetII/ADC, Jasco, Solvent: THF (tetrahydrofuran), Mobile phase: 40° C., polystyrene calibration) is illustrated in upper part of FIG. 3. From the result, it can be known that the synthesized P3HT(2) with vinyl terminal group is a considerably well-controlled polymer of which the number average molecular weight is 12,590 and the molecular weight distribution is 1.09. PDI (polydispersity index) in FIG. 3 represents the value of number average molecular weight (Mn)/weight average molecular weight (Mw), it represents uniformity of molecular weight distribution of polymer, the value is 1 or more, and the value near to 1 means that the molecular weight of polymer is more uniform. Particularly, it can be also recognized that the coupling was shown in front part of the peak as shown in FIG. 3 due to increased reaction time of this experiment.

MALDI-TOF/MS (Matrix assisted laser desorption/ionization time-of-flight mass spectrometry, Voyager-DE STR workstation, Applied Biosystems Inc.) was used for deciding the yield of vinyl group of above synthesized P3HT(2), and the result is represented in bottom side of FIG. 3. Since MALDI-TOF/MS measures absolute molecular weight, it is distinguished from the relative molecular weight obtained by GPC. In the analysis of the MALDI-TOF/MS result, the degree of polymerization corresponding to each peak was recognized by subtracting the value as much as the molecular weight of Br, H, and vinyl group which were substituted at both terminal groups of the polymer from the peak represented in MALDI-TOF/MS and dividing the value by 166.3 g/mol the molecular weight of 3-hexylthiophene which was a monomer of the polymer, and the yield of the polymer with vinyl terminal group could be identified by using the same and it is recognized that the yield of overall vinyl compounds was about 42.77%.

(3) Synthesis of P3HT Macro-Initiator Having the First Generation Grubbs Catalyst Terminal Group

It was synthesized according to following Reaction Formula 7.

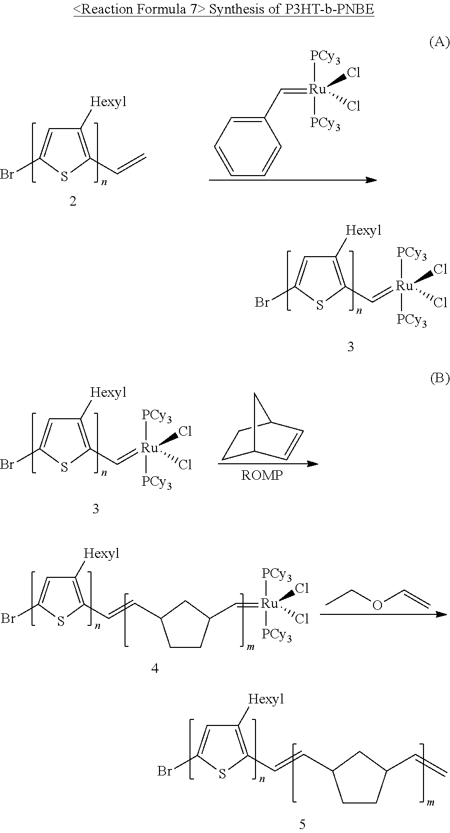

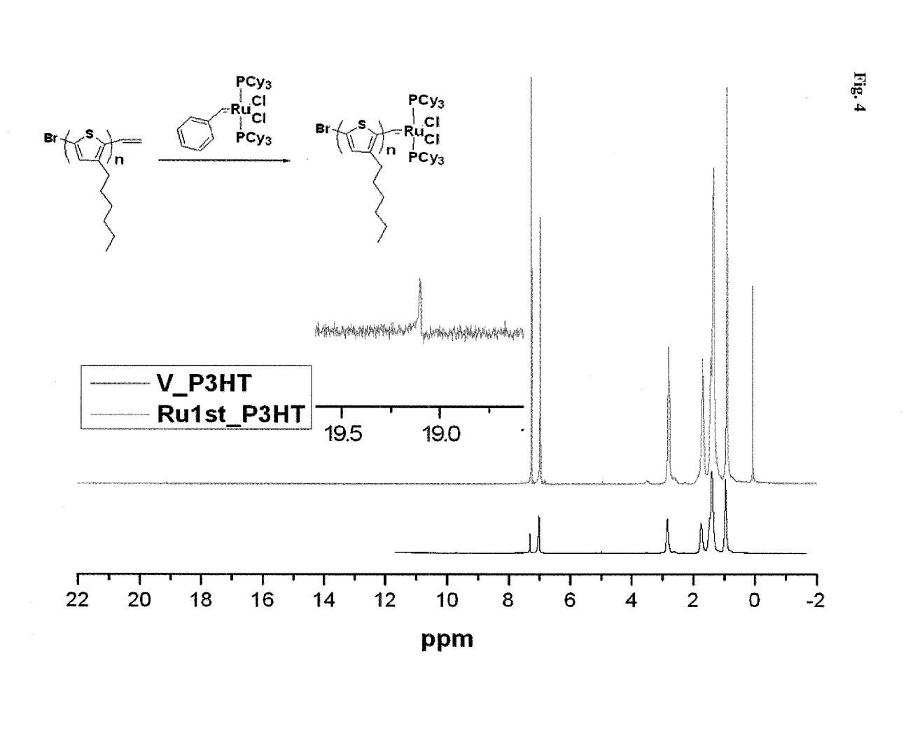

Under argon atmosphere, 0.2 g of the synthesized P3HT(2) having vinyl terminal group was dissolved in 6 ml methylene chloride (MC) and added to a solution in which 0.0304 g of the first generation Grubbs catalyst was dissolved in 1 ml MC. After then, the solution was stirred and reacted at room temperature for 2 hours, purified at −78° C., precipitated in deaerated hexane, and filtered and washed so as to collect the final product. The collected polymer was dried overnight in 25° C. vacuum oven. Whether the reaction was occurred was checked by using ¹H NMR and the result is represented in FIG. 4. According to the result of ¹H NMR analysis, it can be known that the peak corresponding to the vinyl groups of P3HT shown in FIG. 4 was disappeared after introducing the Grubbs catalyst. Furthermore, it can be recognized that the peak corresponding to C—H bond of benzylidene part of the first generation Grubbs catalyst moved from 20 ppm to near 19 ppm after the reaction, and it can be confirmed from the result that the Ru initiator which was a initiator and catalyst was almost quantitatively and selectively introduced to the terminal group of P3HT.

(4) Preparation of Block Copolymer by Using the P3HT Macro-Initiator Having the First Generation Grubbs Catalyst Terminal Group

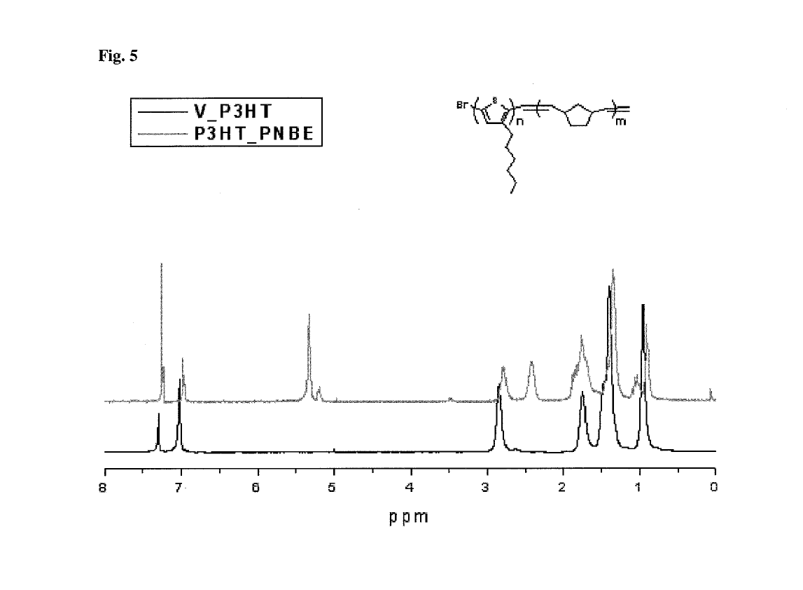

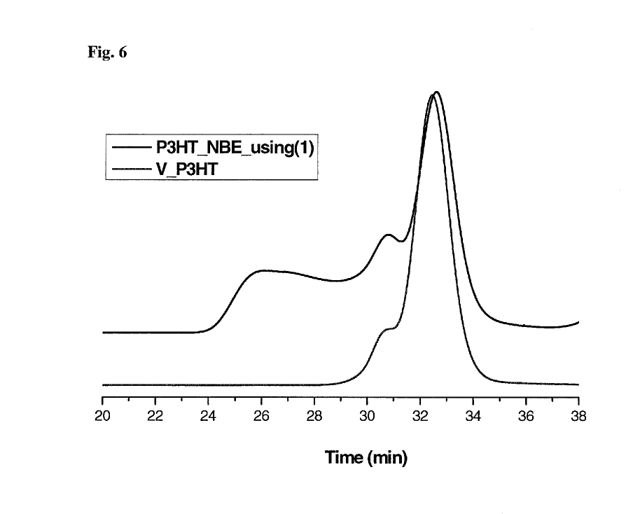

Under argon atmosphere, 0.05 g of the macro-initiator (P3HT with Ru catalyst prepared in Example 1-(3)) was completely dissolved in 3.69 ml MC and added to a solution in which 0.066 g of norbornene was dissolved in 3.9 ml MC, and the solution was stirred at room temperature for 2 hours. After then, the solution was stirred for 1 hour at room temperature after adding 1 ml ethyl vinyl ether, and the P3HT-b-PNBE (polynorbornene) block copolymer was collected by precipitating the same in methanol. The collected P3HT-b-PNBE block copolymer was identified by ¹H NMR and GPC analysis, and the results are represented in FIG. 5 and FIG. 6 respectively. From the result of ¹H NMR analysis, it can be identified that the peaks corresponding to cis-trans structure in PNBE block of P3HT-b-PNBE which were not shown in prior P3HT with vinyl terminal group are shown at near 5 ppm. From the results of FIG. 5 and FIG. 6, it is also identified that the ratios of P3HT and PNBE are 44.6 wt % and 55.4 wt % respectively.

### Example 2

### Preparation of Polyalkylthiophene Block Copolymer by Using the Second Generation Grubbs Catalyst

(1) Synthesis of P3HT Macro-Initiator Having the Second Generation Grubbs Catalyst Terminal Group

Under argon atmosphere, 0.2 g of above synthesized P3HT having vinyl terminal group was dissolved in 6 ml methylene chloride (MC) and added to a solution in which 0.0314 g of the second generation Grubbs catalyst was dissolved in 1 ml MC. After then, the solution was stirred and reacted at room temperature for 2 hours, purified at −78° C., precipitated in deaerated hexane, and filtered and washed so as to collect the final product. The collected polymer was dried overnight in 25° C. vacuum oven. Whether the reaction was occurred was checked by using ¹H NMR according to the same method as in Example 1.

(2) Preparation of Block Copolymer by Using the P3HT Macro-Initiator Having the Second Generation Grubbs Catalyst Terminal Group

Under argon atmosphere, 0.05 g of the macro-initiator (P3HT with Ru catalyst prepared in Example 2-(1)) was completely dissolved in 3.69 ml MC and added to a solution in which 0.066 g of norbornene was dissolved in 3.9 ml MC, and the solution was stirred at room temperature for 2 hours. After then, the solution was stirred for 1 hour at room temperature after adding 1 ml ethyl vinyl ether, and the P3HT-b-PNBE block copolymer was collected by precipitating the same in methanol. The collected P3HT-b-PNBE block copolymer was identified by ¹H NMR and GPC analysis according to the same method as in Example 1.

### Example 3

### Preparation of Polyalkylthiophene Block Copolymer by Using the Third Generation Grubbs Catalyst

(1) Synthesis of P3HT Macro-Initiator Having the Third Generation Grubbs Catalyst Terminal Group

Under argon atmosphere, 0.2 g of above synthesized P3HT having vinyl terminal group was dissolved in 6 ml methylene chloride (MC) and added to a solution in which 0.0327 g of the third generation Grubbs catalyst was dissolved in 1 ml MC. After then, the solution was stirred and reacted at room temperature for 2 hours, purified at −78° C., precipitated in deaerated hexane, and filtered and washed so as to collect the final product. The collected polymer was dried overnight in 25° C. vacuum oven. Whether the reaction was occurred was checked by using ¹H NMR according to the same method as in Example 1.

(2) Preparation of Block Copolymer by Using the P3HT Macro-Initiator Having the Third Generation Grubbs Catalyst Terminal Group

Under argon atmosphere, 0.05 g of the macro-initiator (the polymer prepared in Example 3-(1)) was completely dissolved in 3.69 ml MC and added to a solution in which 0.066 g of norbornene was dissolved in 3.9 ml MC, and the solution was stirred at room temperature for 2 hours. After then, the solution was stirred for 1 hour at room temperature after adding 1 ml ethyl vinyl ether, and the P3HT-b-PNBE block copolymer was collected by precipitating the same in methanol. The collected P3HT-b-PNBE block copolymer was identified by ¹H NMR and GPC analysis according to the same method as in Example 1.

### Example 4

### Preparation of Polyalkylthiophene Block Copolymer by Using the First Generation Grubbs Catalyst

(1) Synthesis of P3HT Having Vinyl Terminal Group

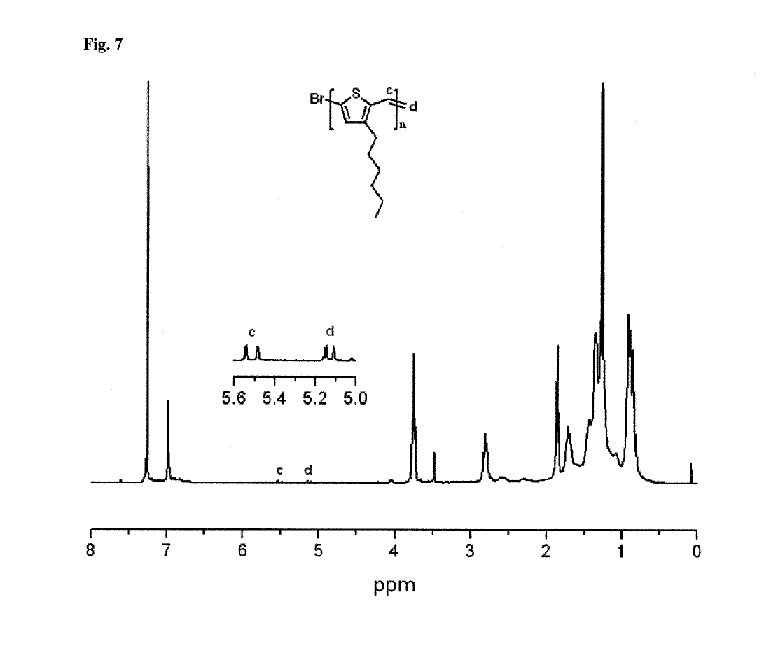

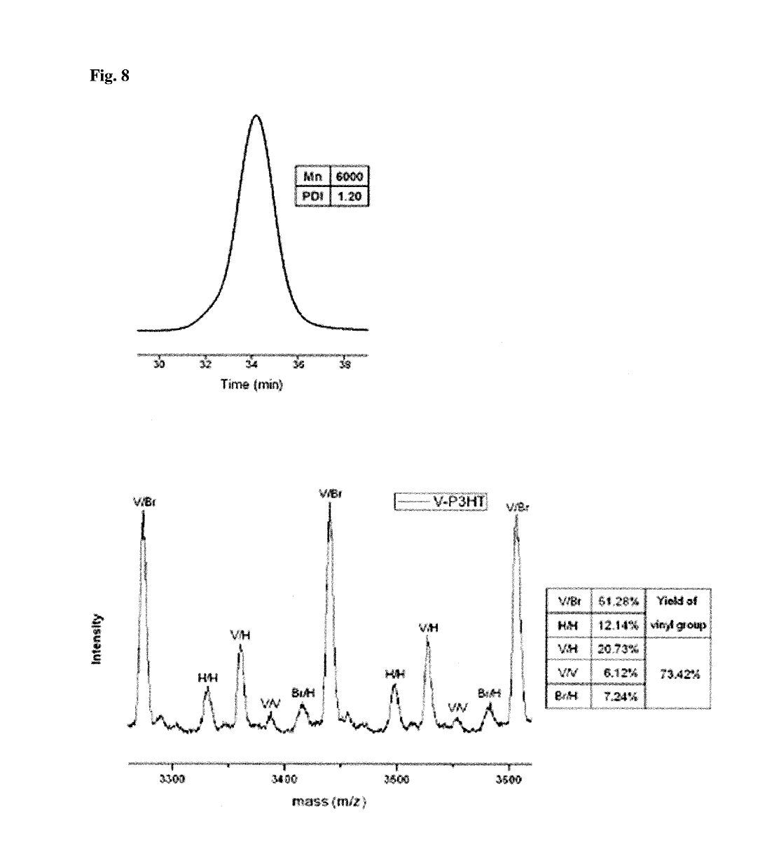

P3HT(2) having vinyl terminal group was synthesized according to the same method as in Example 1-(1). The result of ¹H NMR analysis of the same is represented in FIG. 7. As shown in FIG. 7, there are peaks corresponding to the terminal vinyl group, and it can be known from the result of integral calculation of the peaks that the vinyl group was almost quantitatively introduced to the terminal group of P3HT. The result of GPC analysis is represented in FIG. 8, it can be known that the synthesized P3HT(2) with vinyl terminal group is a considerably well-controlled polymer of which the number average molecular weight is 6,000 and the molecular weight distribution is 1.20. Particularly, it can be recognized that there was no coupling in the experiment even after the reaction.

MALDI-TOF/MS was used for deciding the yield of vinyl group of above synthesized P3HT(2), and the result is represented in FIG. 8. Since MALDI-TOF/MS measures absolute molecular weight, it is distinguished from the relative molecular weight obtained by GPC. In the analysis of the MALDI-TOF/MS result, the degree of polymerization corresponding to each peak was recognized by subtracting the value as much as the molecular weight of Br, H, and vinyl group which were substituted at both terminal groups of the polymer from the peak represented in MALDI-TOF/MS and dividing the value by 166.3 g/mol the molecular weight of 3-hexylthiophene which was a monomer of the polymer, and the yield of the polymer with vinyl terminal group could be identified by using the same and it is recognized that the yield of overall vinyl compounds was about 73.42%.

(2) Synthesis of P3HT Macro-Initiator Having the First Generation Grubbs Catalyst Terminal Group

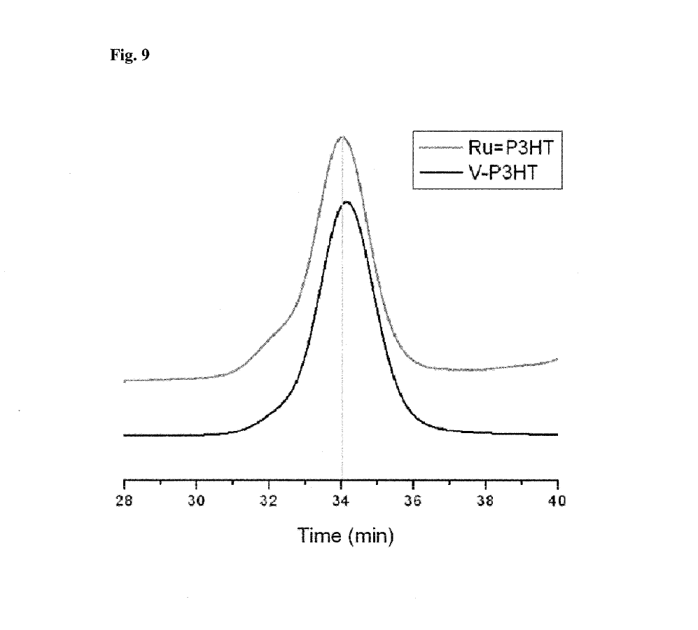

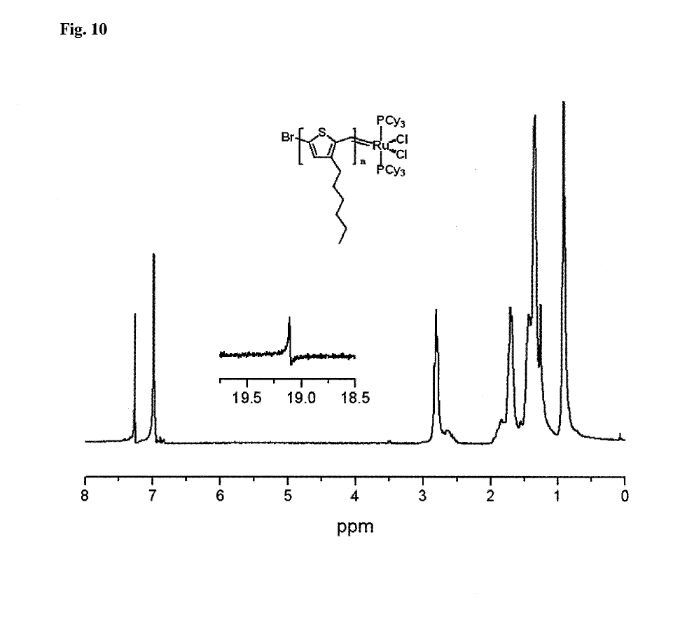

Under argon atmosphere, 0.05 g of above synthesized P3HT(2) having vinyl terminal group was dissolved in 3.26 ml chloroform (CF) and added to a solution in which 0.0246 g of the first generation Grubbs catalyst was dissolved in 0.8 ml CF. After then, the solution was stirred and reacted at room temperature for 6 hours, purified at −78° C., precipitated in deaerated hexane, and filtered and washed so as to collect the final product. The collected polymer was dried overnight in 25° C. vacuum oven. Whether the reaction was occurred was checked by using GPC and ¹H NMR, and the results are represented in FIG. 9 and FIG. 10 respectively.

(3) Preparation of Block Copolymer by Using the P3HT Macro-Initiator Having the First Generation Grubbs Catalyst Terminal Group

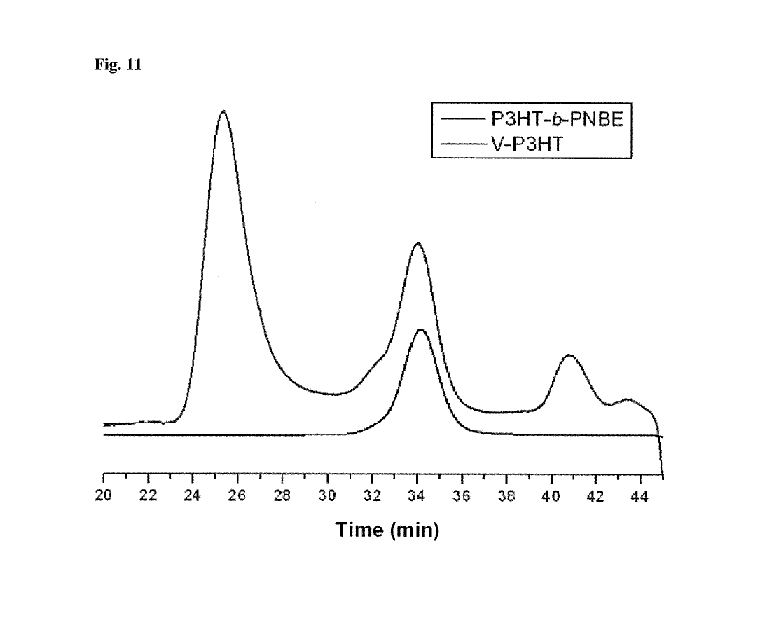

Under argon atmosphere, 0.0242 g of the macro-initiator was completely dissolved in 0.27 ml CF and added to a solution in which 0.0788 g of norbornene was dissolved in 1.64 ml CF, and the solution was stirred at room temperature for 3 hours. After that, the solution was stirred for 1 hour at room temperature after adding 1 ml ethyl vinyl ether, and the P3HT-b-PNBE block copolymer was collected by precipitating the same in methanol. The collected P3HT-b-PNBE block copolymer was identified by GPC analysis, and the result compared to P3HT(2) is represented in FIG. 11.

What is claimed is:

1. A polyalkylthiophene block copolymer having the structure of following Chemical Formula 1: 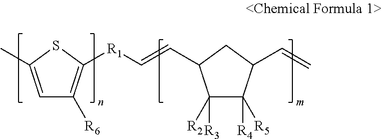
wherein,
R₁ is selected from the group consisting of a substituted or unsubstituted phenyl, a substituted or unsubstituted thiophene, a substituted or unsubstituted pyrrole, a substituted or unsubstituted pyridine, a substituted or unsubstituted triazole ring, a C1-C12 ketone, a C1-C20 ester, and an aliphatic compound of conjugation structure, the substituent included in said substituted phenyl, thiophene, pyrrole, pyridine, or triazole ring is selected from the group consisting of a C1-C20 alkyl, a C2-C20 alkenyl, a C2-C20 alkynyl, a C5-C20 aryl, a C6-C24 alkaryl, and a C6-C24 aralkyl, said aliphatic compound of conjugation structure is selected from the group consisting of a C1-C20 alkyl, a C6-C20 aryl, a C3-C20 cycloalkyl, a heteroatom-containing C1-C20 alkyl, a C6-C20 aryl, a C1-C20 arylalkyl, a C1-C20 alkylaryl, a C1-C20 alkoxy, and a C1-C20 alkyloxy, and said heteroatom is selected from the group consisting of S, O, N, and a halogen atom,
R₂, R₃, R₄, and R₅ are identical or different, and independently selected from group consisting of hydrogen, a hydrocarbyl, a substituted hydrocarbyl, a heteroatom-containing hydrocarbyl, a substituted heteroatom-containing hydrocarbyl, and amino group, or a ring structure formed by R₃ and R₄, or a ring structure formed by heteroatom-containing R₃ and R₄, said hydrocarbyl is selected from the group consisting of a substituted or unsubstituted C1-C20 alkyl, a substituted or unsubstituted C2-C20 alkenyl, a substituted or unsubstituted C2-C20 alkynyl, a substituted or unsubstituted C5-C20 aryl, a substituted or unsubstituted C6-C24 alkaryl, and a substituted or unsubstituted C6-C24 aralkyl, the substituent included in said substituted alkyl, alkenyl, alkynyl, aryl, alkaryl, or aralkyl is selected from the group consisting of a C1-C20 alkyl, a C2-C20 alkenyl, a C2-C20 alkynyl, a C5-C20 aryl, a C6-C24 alkaryl, and a C6-C24 aralkyl, and said heteroatom is selected from the group consisting of S, O, N, and a halogen atom,
R₆ is a C1-C12 alkyl group,
n is an integer of 5 to 400, and
m is an integer of 5 to 20,000.

2. The block copolymer according to claim 1, wherein the polyalkylthiophene has a head to tail tacticity.

3. The block copolymer according to claim 2, wherein the polyalkylthiophene has a degree of head to tail tacticity of 90% or more.

4. A polymer-catalyst complex including a polymer having a structure of following Chemical Formula 2, and a transition metal catalyst combined to R₁ of terminal group of the polymer: 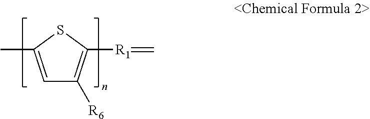
wherein,
R₁ is selected from the group consisting of a substituted or unsubstituted phenyl, a substituted or unsubstituted thiophene, a substituted or unsubstituted pyrrole, a substituted or unsubstituted pyridine, a substituted or unsubstituted triazole ring, a C1-C12 ketone, a C1-C20 ester, and an aliphatic compound of conjugation structure, the substituent included in said substituted phenyl, thiophene, pyrrole, pyridine, or triazole ring is selected from the group consisting of a C1-C20 alkyl, a C2-C20 alkenyl, a C2-C20 alkynyl, a C5-C20 aryl, a C6-C24 alkaryl, and a C6-C24 aralkyl, said aliphatic compound of conjugation structure is selected from the group consisting of a C1-C20 alkyl, a C6-C20 aryl, a C3-C20 cycloalkyl, a heteroatom-containing C1-C20 alkyl, a C6-C20 aryl, a C1-C20 arylalkyl, a C1-C20 alkylaryl, a C1-C20 alkoxy, and a C1-C20 alkyloxy, and said heteroatom is selected from the group consisting of S, O, N, and a halogen atom,
R₆ is a C1-C12 alkyl group, and
n is an integer of 5 to 400.

5. The polymer-catalyst complex according to claim 4, wherein the transition metal catalyst includes at least one selected from the group consisting of ruthenium (Ru), molybdenum (Mo), rhodium (Rh), tantalum (Ta), and osmium (Os).

6. The polymer-catalyst complex according to claim 4, having a structure selected from the group consisting of following Chemical Formulae 3 to 14:

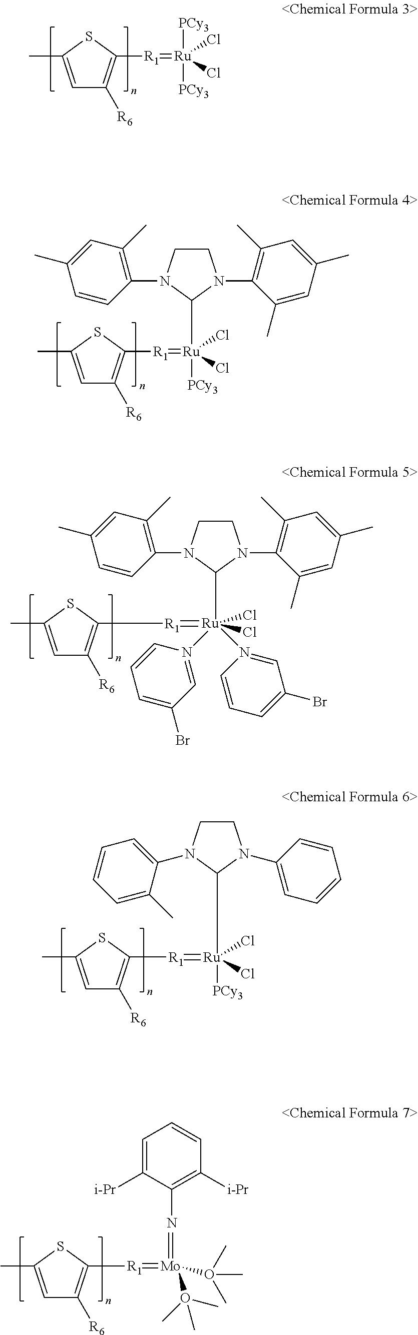

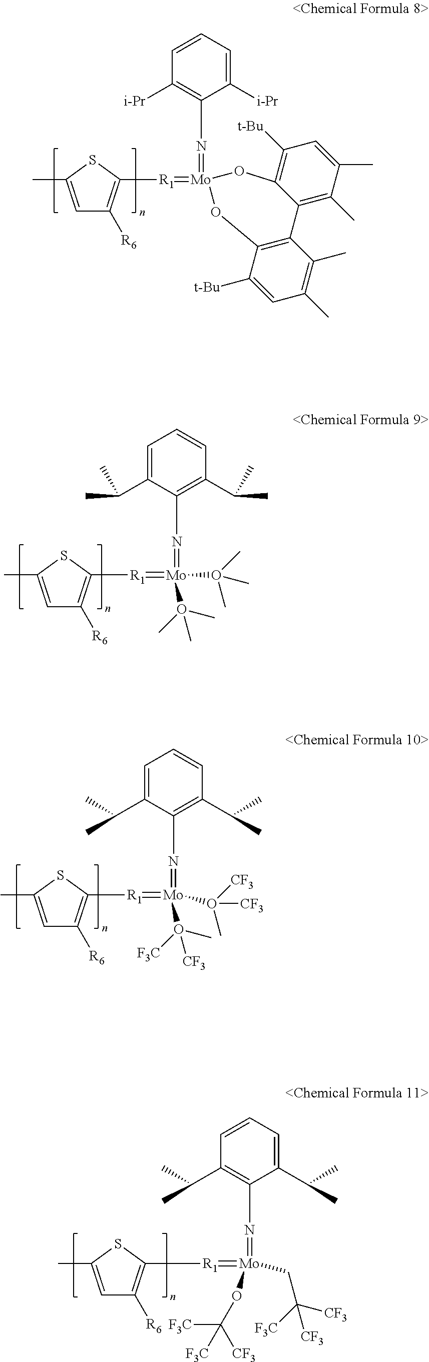

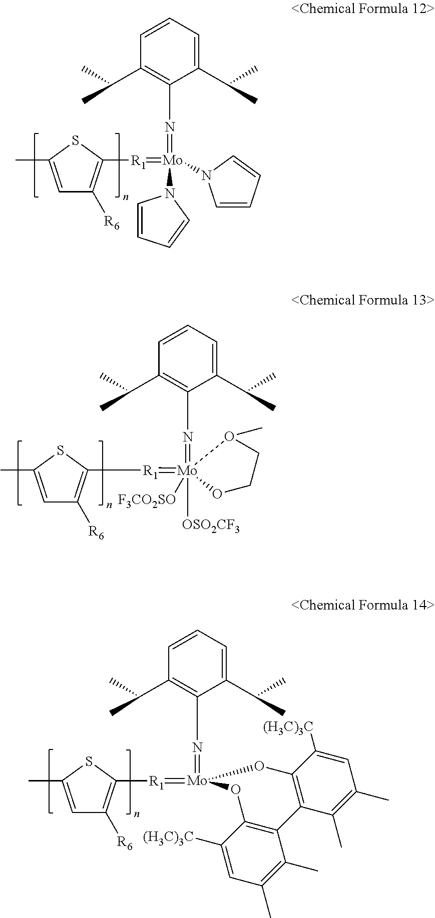

7. A method of preparing the polyalkylthiophene block copolymer of Chemical Formula 1, including the steps of:
adding a norbornene-based compound of following Chemical Formula 15 to the polymer-catalyst complex according to any one of claims 4 to 6 and carrying out a ring-opening metathesis reaction; and
terminating the reaction by eliminating the catalyst: 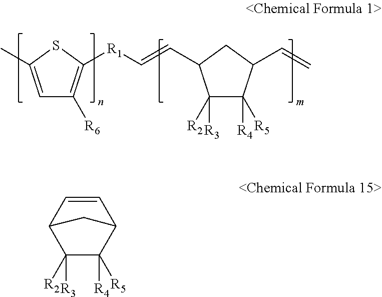
wherein,
R₁ is selected from the group consisting of a substituted or unsubstituted phenyl, a substituted or unsubstituted thiophene, a substituted or unsubstituted pyrrole, a substituted or unsubstituted pyridine, a substituted or unsubstituted triazole ring, a C1-C12 ketone, a C1-C20 ester, and an aliphatic compound of conjugation structure, the substituent included in said substituted phenyl, thiophene, pyrrole, pyridine, or triazole ring is selected from the group consisting of a C1-C20 alkyl, a C2-C20 alkenyl, a C2-C20 alkynyl, a C5-C20 aryl, a C6-C24 alkaryl, and a C6-C24 aralkyl, said aliphatic compound of conjugation structure is selected from the group consisting of a C1-C20 alkyl, a C6-C20 aryl, a C3-C20 cycloalkyl, a heteroatom-containing C1-C20 alkyl, a C6-C20 aryl, a C1-C20 arylalkyl, a C1-C20 alkylaryl, a C1-C20 alkoxy, and a C1-C20 alkyloxy, and said heteroatom is selected from the group consisting of S, O, N, and a halogen atom,
R₂, R₃, R₄, and R₅ are identical or different, and independently selected from group consisting of hydrogen, a hydrocarbyl, a substituted hydrocarbyl, a heteroatom-containing hydrocarbyl, a substituted heteroatom-containing hydrocarbyl, and amino group, or a ring structure formed by R₃ and R₄, or a ring structure formed by heteroatom-containing R₃ and R₄, said hydrocarbyl is selected from the group consisting of a substituted or unsubstituted C1-C20 alkyl, a substituted or unsubstituted C2-C20 alkenyl, a substituted or unsubstituted C2-C20 alkynyl, a substituted or unsubstituted C5-C20 aryl, a substituted or unsubstituted C6-C24 alkaryl, and a substituted or unsubstituted C6-C24 aralkyl, the substituent included in said substituted alkyl, alkenyl, alkynyl, aryl, alkaryl, or aralkyl is selected from the group consisting of a C1-C20 alkyl, a C2-C20 alkenyl, a C2-C20 alkynyl, a C5-C20 aryl, a C6-C24 alkaryl, and a C6-C24 aralkyl, and said heteroatom is selected from the group consisting of S, O, N, and a halogen atom,
R₆ is a C1-C12 alkyl group,
n is an integer of 5 to 400, and
m is an integer of 5 to 20,000.
